(19) United States
(12) Patent Application Publication
(10) Pub. No.: US 2006/0172050 A1
(43) Pub. Date: Aug. 3, 2006

(54) Method and apparatus for making cookie pieces for use as inclusions

(75) Inventors: Sidney E. Harvey, Sherwood, OR (US); Valentine Brown III, Vancouver, WA (US); Jeffery W. Richtmyre, Vancouver, WA (US); Dirk W. Moulton, Oregon City, OR (US); Rosemary L. Hippe, Vancouver, WA (US)

Correspondence Address: CHERNOFF, VILHAUER, MCCLUNG & STENZEL, 1600 ODS TOWER, 601 SW SECOND AVENUE, PORTLAND, OR, 97204-3157, US

(73) Assignee: Kerry Group Services International Limited

(21) Appl. No.: 11/051,106

(22) Filed: Feb. 3, 2005

(51) Int. Cl. A23L 1/00

(52) U.S. Cl. 426/516

(57) ABSTRACT

An apparatus for making cookie pieces comprises one or more dies through which continuous ropes of cookie dough are extruded onto a moving band. The band then passes through an oven in which the cookie dough ropes are baked. The ropes of baked cookie dough then pass through a cutter where they are cut into individual cookie pieces. The cutter has a plurality of thin elongate blades which extend across the band. The blades are mounted on a carrier which causes them to move with the band at the same speed as the band during the cutting process. The carrier also orients the blades normal to the plane of the band and causes them to gradually cut the ropes by moving toward the band during the cutting process. The carrier then causes the blades to quickly move away from the band clear of the just-cut cookie pieces.

### BACKGROUND OF THE INVENTION

This invention relates to a method and apparatus for producing small cookie pieces having a uniform size for use as inclusions in ice cream.

It has become common to place small cookie or cake pieces in ice cream. These pieces need to all be approximately the same size to provide the look and consistency that ice cream manufacturers desire. To accomplish this the cookie pieces must be made in the desired size in the first instance rather than breaking up or cutting larger cookies into smaller pieces. Heretofore this has been accomplished by extruding a plurality of thin ropes of cookie dough onto a moving band. The ropes are then cut into the desired length by a wire which extends across the band and reciprocates through the dough as the band moves the dough past it. The band then passes through an oven where the cut cookie pieces are baked. There are two problems with this process. First the wire tends to stick to the moist cookie dough and when the wire is retracted some of the cookie pieces stick to the wire and are pulled upwardly off of the band. Some of these pieces land on top of other cookie pieces and if left these compound pieces would be baked together. Because the compound pieces would be too large, it is necessary to hand pick all of the stuck-together pieces from the band before the band enters the oven. In addition, since cookies expand when they are baked, adjacent pieces can expand into one another and become baked together. Thus it is necessary to hand pick the baked together pieces from the band after the band leaves the oven. This double hand picking is labor-intensive and increases the cost of producing cookie pieces of this type. In addition, the output of each baking line is reduced due to the number of unusable pieces and the line is less productive than it should be, which also increases the cost of producing the cookie pieces.

The subject invention overcomes these problems by placing a cutter immediately downstream of where extruded ropes of cookie dough that have been baked exit the oven on a moving band.

### BRIEF DESCRIPTION OF THE DRAWINGS

FIG. 1 is a schematic plan view of an apparatus for making cookie pieces embodying the subject invention.

FIG. 2 is a plan view, partially broken away to show hidden detail, of the cutter in the apparatus shown in FIG. 1.

FIG. 3 is a side elevation view, partially broken away to show detail taken on the line 3-3 of FIG. 2.

FIGS. 4, 5 and 6 are perspective views showing the details of the cutter blades used in the cutter shown in FIG. 3.

### DETAILED DESCRIPTION OF PREFERRED EMBODIMENTS

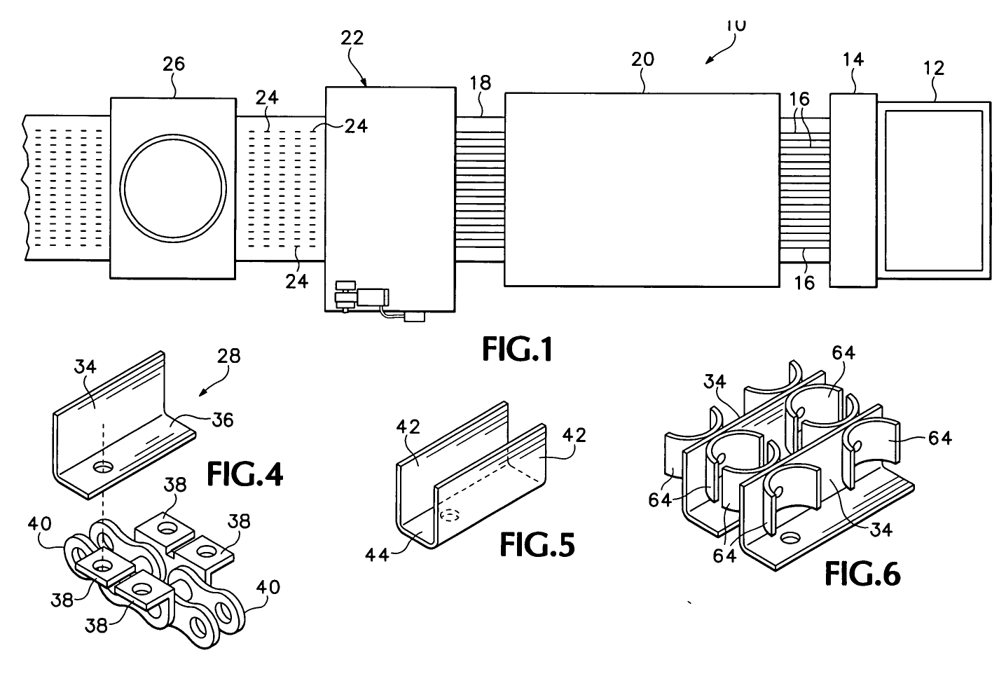

Referring to FIG. 1 of the drawings, an apparatus for making cookie pieces 10 comprises a mixer 12 which mixes the desired ingredients into cookie dough. The dough is deposited into an extruder 14 having a plurality of dies (not shown) each of which extrudes a continuous rope 16 of cookie dough onto a moving band 18. The band 18 passes through an oven 20 in which the cookie dough ropes are baked. This much of the apparatus is old, with the exception that in the prior art apparatus of this type the cookie dough ropes are cut into discrete cookie pieces before they pass into the oven for baking. Instead, in the subject apparatus a cutter 22 cuts the baked cookie ropes into discrete cookie pieces 24 after the ropes have passed through the oven. After the cookie pieces have been cut the band passes through a cooler 26 where the cookie pieces are cooled prior to packaging.

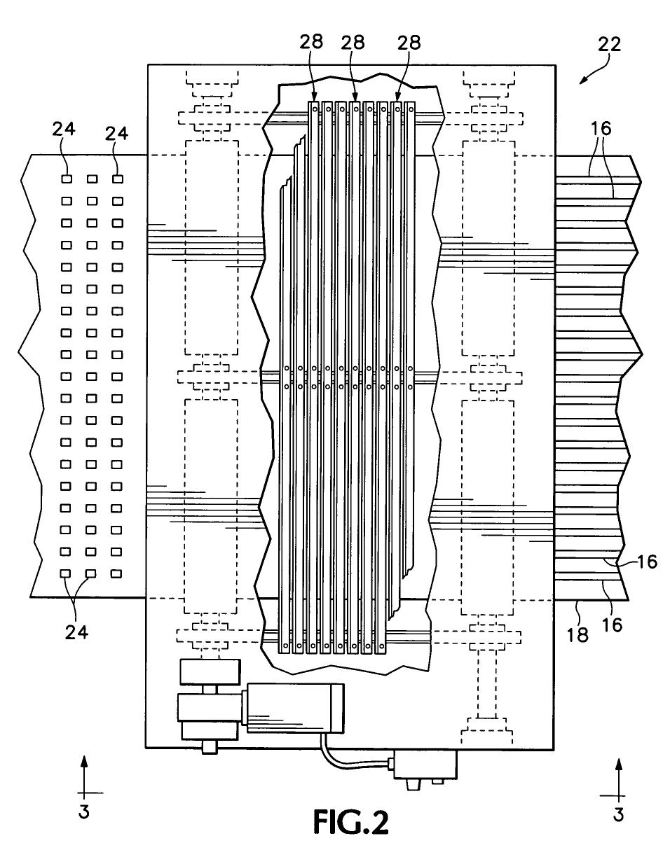

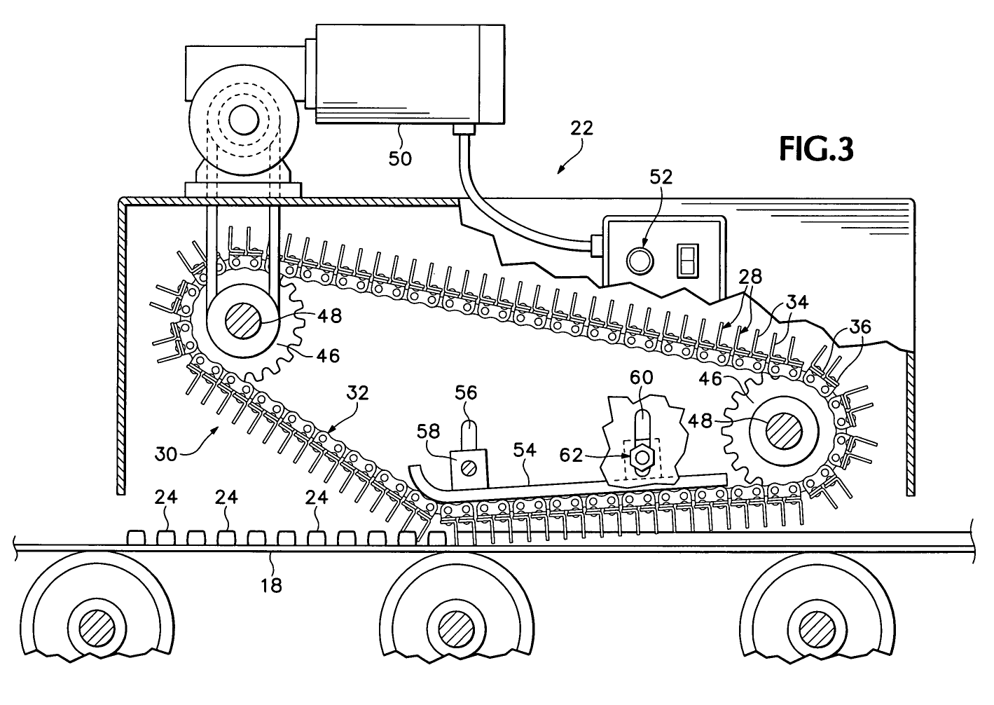

Referring now in particular to FIGS. 2 and 3, the cutter 22 includes a plurality of thin elongate blades 28 which extend across the band 18 normal to its direction of travel. The blades 28 are attached to a carrier 30, which is shown in the drawings as three side-by-side endless chains 32. In the embodiment illustrated in FIGS. 2-4, the blades 28 are L-shaped in cross-section with one leg forming a cutting surface 34 and the other leg forming a mounting surface 36. The mounting surface is attached to tabs 38 located on the links 40 of the chains 32. Chains having links with mounting tabs are known in the prior art. In the embodiment illustrated two blades 28 are attached to each link, however, there could be more or less depending on the size of the links and the desired length of the cookie pieces 24. Preferably the cookie dough rope diameter and the cutter spacing is such that the baked cookie pieces will be between ¼ inch by ¼ inch and ⅜ inches by ⅜ inches. Alternatively, the cutting blades could have a U-shaped cross section (FIG. 5) with the two legs of the U forming two cutting surfaces 42 and the base forming a mounting surface 44. In either case, the blades are preferably made from spring steel and the cutting surfaces preferably are coated with a non-stick coating, such as TEFLON. Each chain extends over a pair of sprockets 46 and the aligned sprockets of the three chains are mounted on a common rotatable shaft 48. One of the shafts 48 is driven by a motor 50. The carrier is arranged such that the blades are located directly above the band and their cutting surfaces are oriented substantially perpendicular to the plane of the band over a portion of their travel, and are completely removed from the band over the remainder of their travel. The carrier causes the blades to travel at substantially the same speed as the band when they are located over the band. Some variation in this speed will be provided, however, as will be more fully explained later. A controller 52 allows the speed of the carrier to be varied.

The carrier is also arranged so that when a blade 28 first moves over the band 18 the cutting surface is located above the baked cookie ropes 16. As the blade moves along with the band the cutting surface gradually moves towards the band and penetrates the ropes. At the point where the cutting surface fully penetrates the ropes the carrier causes the blade to move away from the band by rotating it upwardly in the direction of band travel. Thus, the blade is quickly separated from the cookie pieces.

Referring now to FIG. 6, if it is desired to make the resulting cookie pieces have rounded ends rather than being rectangular, cutting elements 64 can be attached to the blades 28 in alignment with the ropes 16. By making the cutting elements 64 semicircular and putting opposed cutting elements on adjacent blades, the resulting cookies can be made round.

In order to obtain the proper pressure on the chains when they are positioned over the band, a hold down plate 54 extends above the chains 32 in this area. The exit, or downstream end, of the hold down plate curves upwardly and creates the point at which the chains turn upwardly to rotate the blades 28 away from the cut cookie pieces. This end of the hold down plate is rotatably mounted on a stand 56 through a pin 58. The other end of the hold down plate is slidably mounted on a post 60 through a locking mechanism 62. This allows the angle of the hold down plate to be adjusted relative to the band 18. This in turn allows adjusting how rapidly the blade 28 moves towards the band and penetrates the baked cookie ropes.

By inserting the cutting surfaces 34 of the blades 28 gradually into the baked cookie ropes immediately after they come out of the oven, the ropes are soft enough that the blades will cut them without crushing them. However, because the ropes are baked the cutting surfaces will cut clean and will not stick to the ropes. Moving the blades with the band 18 is critical in accomplishing this. Thus the ability to control the speed that the chains are moving over the area where cutting occurs is important. It has been found that having the chains move at a slightly greater speed than the band is preferable under some circumstances. In addition, the formula of the dough and how long and at what temperature the dough is baked all affect the operation of the cutters. It is desirable that there be minimal expansion of the ropes during baking, that the baked cookie ropes have an even crumb structure, that the baked cookie ropes have low, uniform moisture throughout and that the baked cookie ropes do not have hard shells. Preferably the moisture content of the baked cookie ropes is 5 to 6 percent. This is accomplished by using lower amounts of fat and sugar than normal in cookies of this type. In addition it is best if the dough does not utilize eggs and that the only moisture come from molasses or the moisture in the margarine that is used in the dough.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

1. An apparatus for making cookie pieces, comprising:
(a) at least one die which extrudes a continuous rope of cookie dough;
(b) a moving band which is configured to receive said ropes of cookie dough;
(c) an oven which said band passes through and bakes said ropes of cookie dough; and
(d) a cutter which cuts said baked cookie ropes into a plurality of discrete cookie pieces after said band has passed through said oven.

2. The apparatus of claim 1 including a mixer which mixes said cookie dough before it is extruded by said dies.

3. The apparatus of claim 1 including a cooler which cools said cookie pieces after they have been cut by said cutter.

4. The apparatus of claim 1 wherein said band travels in a predetermined direction at a predetermined speed, wherein said cutter comprises:
(a) A plurality of thin elongate blades which extend across said band normal to the direction said band travels;
(b) a carrier which carries said blades, and causes said blades to move along with said band at approximately said predetermined speed;
(c) said blades have cutting surfaces and said carrier orients said cutting surface normal to the plane of said band and causes said blades to move toward said band until said cutting surfaces substantially penetrate said baked cookie ropes and then move away from said band until said cutting surfaces are substantially free of the cut cookie pieces.

5. The apparatus of claim 4 wherein said carrier causes said blades to rotate toward the direction said band travels as they move away from said band.

6. The apparatus of claim 4 wherein said carrier comprises a plurality of side-by-side endless chains.

7. The apparatus of claim 6 wherein said blades are L-shaped in cross section with one leg of the L forming the cutting surface and the other leg forming a mounting surface which is attached to said chains.

8. The apparatus of claim 7 wherein said chains comprise a plurality of links which are joined end to end.

9. The apparatus of claim 8 wherein one blade is attached to each link.

10. The apparatus of claim 8 wherein multiple blades are attached to each link.

11. The apparatus of claim 10 wherein two blades are attached to each link.

12. The apparatus of claim 6 wherein said blades are U-shaped in cross section with legs of the U forming a pair of cutting surfaces and a base of the U forming a mounting surface which is attached to said chains.

13. The apparatus of claim 12 wherein said chains comprise a plurality of links which are joined end to end.

14. The apparatus of claim 13 wherein one blade is attached to each link.

15. The apparatus of claim 4 wherein said cutting surfaces are covered with a non-stick coating.

16. The apparatus of claim 4 including a hold down plate which prevents said chains from being displaced away from said band as said cutting surfaces cut into said baked cookie ropes.

17. The apparatus of claim 16 wherein said hold down plate angles downwardly toward said band moving in the direction that said band is moving.

18. The apparatus of claim 17 including an adjustment mechanism which allows the angle of said hold down plate to be adjusted.

19. The apparatus of claim 4 wherein said blades are made from spring steel.

20. The apparatus of claim 4 wherein said blades have arcuate cutting elements attached thereto.

21. The apparatus of claim 20 wherein said cutting elements are semicircular in cross section.

22. A method for making cookie pieces, comprising:
(a) Providing a moving band;
(b) placing one or more continuous ropes of unbaked cookie dough on said band with said ropes being oriented longitudinally along the direction said band is moving;
(c) baking said cookie dough ropes; and
(d) immediately after said ropes are baked cutting the resulting baked cookie ropes transversely to their elongate lengths.

23. The method of claim 22 wherein said ropes are cut by a blade which is oriented normal to the direction said band is moving.

24. The method of claim 23 wherein said band is moving at a predetermined speed, including the step of moving said blade in the same direction said band is moving at approximately said predetermined speed.

25. The method of claim 24 including the steps of:
(a) orienting said blade so that its cutting surface is normal to the plane of said band;
(b) moving said blade toward said band until its cutting surface substantially penetrates said baked cookie ropes; and
(c) thereafter moving said blade away from said band until the cutting surface is substantially free from the cut cookie pieces.

26. The method of claim 25 including the step of rotating said blade in the direction said band is moving as said blade is moved away from said band.

27. A cutter for cutting a baked cookie rope traveling on a moving band into a plurality of discrete cookie pieces, said cutter comprising:
(a) a plurality of thin elongate blades which extend across said band normal to the direction said band travels;
(b) a carrier which carries said blades, and causes said blades to move along with said band at approximately said predetermined speed; and
(c) said blades have a cutting surface and said carrier orients said cutting surface normal to the plane of said band and causes said blades to move toward said band until said blades substantially penetrate said baked cookie ropes and then move away from said band until they are substantially free from the cut cookie pieces.

28. The cutter of claim 27 wherein said carrier causes said blades to rotate toward the direction said band travels as they move away from said band.

29. The cutter of claim 27 wherein said carrier comprises a plurality of side-by-side endless chains.

30. The cutter of claim 29 wherein said blades are L-shaped in cross section with one leg of the L forming the cutting surface and the other leg forming a mounting surface which is attached to said chains.

31. The cutter of claim 30 wherein said chains comprise a plurality of links which are joined end to end.

32. The cutter of claim 31 wherein one blade is attached to each link.

33. The cutter of claim 31 wherein multiple blades are attached to each link.

34. The cutter of claim 33 wherein two blades are attached to each link.

35. The cutter of claim 29 wherein said blades are U shaped in cross section with a leg of the U forming a pair of cutting surfaces and a base of the U forming a mounting surface which is attached to said chains.

36. The cutter of claim 35 wherein said chains comprise a plurality of links which are joined end to end.

37. The cutter of claim 36 wherein one blade is attached to each link.

38. The cutter of claim 27 wherein said cutting surfaces are covered with a nonstick surface.

39. The cutter of claim 27 including a hold down plate which prevents said chains from being displaced away from said band as said blades cut into said baked cookie ropes.

40. The cutter of claim 38 wherein said hold down plate angles downwardly extending toward said band along the direction said band is moving.

41. The cutter of claim 39 including an adjustment mechanism which allows the angle of said hold down plate to be adjusted.

42. The cutter of claim 27 wherein said blades are made from spring steel.

43. The cutter of claim 27 wherein said blades have arcuate cutting elements attached thereto.

44. The cutter of claim 43 wherein said cutting elements are semicircular in cross section.
